(19) United States
(12) Patent Application Publication
(10) Pub. No.: US 2013/0141338 A1
(43) Pub. Date: Jun. 6, 2013

(54) METHOD AND DEVICE FOR CONTACT AND PERCOLATION HYBRID MODE TRANSPARENT FORCE SENSOR

(71) Applicants: Yi Wei, Chandler, AZ (US); Aroon V. Tungare, Winfield, IL (US)

(72) Inventors: Yi Wei, Chandler, AZ (US); Aroon V. Tungare, Winfield, IL (US)

(73) Assignee: Motorola Solutions, Inc., Schaumburg, IL (US)

(21) Appl. No.: 13/309,929

(22) Filed: Dec. 2, 2011

(51) Int. Cl. G06F 3/041

(52) U.S. Cl. 345/173

(57) ABSTRACT

A method and system for a touch screen having a contact and percolation hybrid operating mode includes a top layer, an intermediate layer, and a bottom layer. The top layer has a top side receiving a touch input. The intermediate layer is disposed beneath the top layer. The intermediate layer measures pressure data where the pressure data is indicative of distinguishing the touch input between a first touch and a second touch. The first touch has a first pressure less than a second pressure of the second touch. The bottom layer is disposed beneath the intermediate layer and receives at least one of position data, time data, and the pressure data of the touch input.

### FIELD OF THE DISCLOSURE

The present disclosure relates generally to a touch sensor and more particularly to the touch sensor incorporating a pressure measurement.

### BACKGROUND

An electronic device may incorporate a variety of different input technologies. For example, the electronic device may include a keypad to allow a user to enter inputs. In another example, the electronic device may include a touch sensor that enables a user to enter inputs. Conventional touch technologies include many different types, each with its own set of advantages and disadvantages. A fundamental reason for the vast types of touch technologies is that different interpretation methods are used to detect touch inputs. For example, capacitive touch screens interpret a human touch as a change in capacitance measured by the touch panel. Other examples include heat sensitive touch screens or positional sensitive touch screens. Since interpretations of touch inputs are not always correct under different scenarios, it leads to a unique situation where all current technologies have respectively severe limitations in some aspects of touch detection.

An input entered through a touch screen consists of three degrees of freedom: position, time, and force. However, conventional touch screens sense only two of the three possible degrees of freedom of touch input, namely position and time. Much of the information in the third dimension of force is lost in touch detection. The result of this partial recognition of user input results in less intuitive interpretations and more cumbersome touch inputs.

Accordingly, there is a need for a method and system for entering touch inputs that further incorporates a pressure measurement.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a touch sensor in accordance with some embodiments.

FIG. 2 is the touch sensor of FIG. 1 upon applying a light touch input in accordance with some embodiments.

FIG. 3 is the touch sensor of FIG. 1 upon applying a hard press input in accordance with some embodiments.

FIG. 4 is a graphical representation of a conductance-force curve for the touch sensor of FIG. 1 in accordance with some embodiments.

FIG. 5 is a flowchart of a method for determining a touch input for the touch sensor of FIG. 1 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method and system for a touch screen having a contact and percolation hybrid operating mode comprises a top layer, a bottom layer, and an intermediate layer. The top layer has a top side receiving a touch input. The intermediate layer is disposed beneath the top layer. The intermediate layer measures pressure data where the pressure data is indicative of distinguishing the touch input between a first touch and a second touch. The first touch has a first pressure less than a second pressure of the second touch. The bottom layer is disposed beneath the intermediate layer and receives at least one of position data, time data, and the pressure data of the touch input.

The exemplary embodiments may be further understood with reference to the following description and the appended drawings, wherein like elements are referred to with the same reference numerals. The exemplary embodiments describe a touch screen configured to detect multiple degrees of freedom in a touch action. Specifically, the touch screen is configured to determine a position, a time, and a force of a touch action on the touch screen. As will be described in further detail below, the touch screen incorporates a feature that is capable of distinguishing between a light touch and a hard press in the force degree of freedom in the touch action. The touch screen, the components thereof, the degrees of freedom, and a related method will be discussed in further detail below.

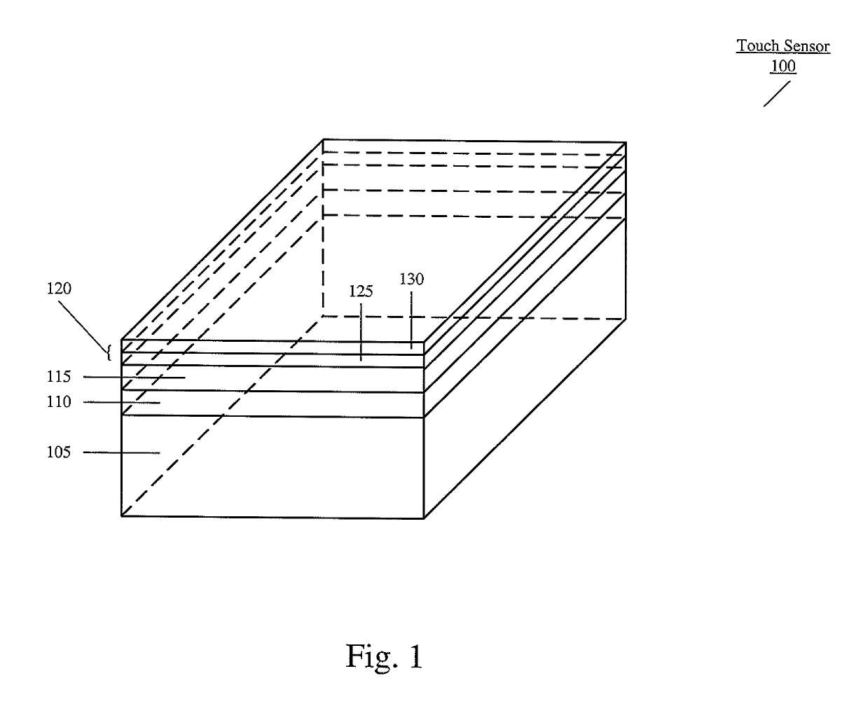

FIG. 1 is a touch sensor 100 in accordance with an exemplary embodiment of the present invention. The touch screen 100 may be for any electronic device that is configured to receive inputs. The electronic device may be any type such as a desktop monitor, a laptop, a cellular phone, a personal digital assistant, etc. The touch screen 100 may further provide additional functionalities such as being adapted for a display of the electronic device, thereby showing data to a user. As will be discussed in further detail below, the touch screen 100 according to the exemplary embodiments enable position data, time data, and force data to be measured for each touch action that is applied on the touch screen 100. Specifically, the touch screen 100 detects touch by measuring a local pressure exerted on the touch screen 100. Since a user feels touch by the pressure felt by a finger tip used for the touch action, there is no interpretation involved. That is, what the user feels is what the touch screen 100 measures, thereby eliminating virtually all limitations of conventional touch screen limitations. The touch screen 100 may include a substrate 105, a bottom transparent conducting layer/traces such as indium tin oxide layer (ITO) 110, a transparent polymer-conductor composite layer (TPCC) 115, and a top layer 120 including a top transparent conducting layer/traces such as ITO 125 and a flexible transparent material such as polyethylene terephthalate layer (PET) 130.

It should be noted that the use of ITO and PET as described in the present application are exemplary only. The bottom ITO 110, the top ITO 125 and the PET 130 may represent any substantially similar layers that are capable of performing the functions of the ITO and the PET. Thus, the ITO may represent any transparent conducting layer or conducting trace while the PET may represent any flexible transparent material. It should also be noted that the ITO may also be made with a non-transparent material such as a metal trace but in a thin enough width (e.g., 5 microns or less) so that it is nearly invisible. For simplicity, the bottom layer will be referred as the ITO 110, the portion of the top layer 120 will be referred as the ITO 125 and the other portion of the top layer 120 will be referred as the PET 130.

The substrate 105 may provide a conventional functionality for the touch screen 100. Specifically, the substrate 105 may be a base layer in which further layers of the touch screen 100 are disposed thereupon. The substrate 105 may be a glass substrate. However, it should be noted that the use of glass in the substrate 105 is only exemplary. For example, if the touch screen 100 were to be adapted for a display, the glass substrate 105 may be manufactured with any compound that is transparent and/or translucent. In another example, if the touch screen 100 were part of an input area of a housing of the electronic device, the substrate 105 may be manufactured with any compound (e.g., plastic) that is configured to support the layers disposed thereupon.

The bottom ITO 110 and the top ITO 125 may also provide conventional functionalities for the touch screen 100. The ITOs 110, 125 may be manufactured conventionally with conventional components such as a solid solution of indium (III) oxide (In₂O₃) and tin (IV) oxide (SnO₂), in particular 90% In₂O₃ and 10% SnO₂ by weight. The ITOs 110, 125 may be thin enough to maintain the electrical conductivity and optical transparency desired for the touch screen 100. Specifically, the ITOs 110, 125 may be transparent and colorless, particularly when the touch screen 100 is incorporated into a display of the electronic device. Furthermore, as will be described in further detail below, the top ITO 125 being part of the top layer 120 may be sufficiently flexible to receive the touch action having a light touch or a hard press. The bottom ITO 110 may also be sufficiently flexible but in other embodiments, may be rigid. In addition, the bottom ITO 110 and the top ITO 125 may be configured to receive and/or transmit data related to the touch input to a processor of an electronic device in which the touch screen 100 is incorporated. Specifically, the data of the touch input may be interpreted by the processor.

The PET 130 may also provide conventional functionalities for the touch screen 100. The PET 130 may be manufactured conventionally with conventional components such as a thermoplastic polymer resin of the polyester family. The PET 130 may also be either amorphous to retain a transparent quality or semi-crystalline polymer to appear transparent. As will be described in further detail below, the PET 130 being part of the top layer 120 may be sufficiently flexible to receive the touch action having a light touch or a hard press.

The TPCC 115 may be a transparent distributed force sensing layer. The TPCC 115 may consist of a transparent conducting oxide (TCO) nano particles dispersed in a transparent polymer matrix. As a result, the TPCC 115 is configured so that the resistance thereof becomes highly sensitive to pressure near the composition of a percolation threshold. Therefore, the TPCC 115 may be configured to measure force and/or pressure in the range of a human touch on the touch screen 100.

According to the exemplary embodiments of the present invention, the pressure on the touch screen 100 is measured by the resistance change upon applied pressure on the top layer 120. Utilizing a hybrid operating mode for more than one touch input (e.g., light touches and hard presses), the resistance of each individual pixel first decreases from the contact area increasing, which is a result from the applied pressure of the touch action. The TPCC 115 is configured to be very sensitive to small forces that may be indicative of light touches. Furthermore, with at least one of the layers of the touch sensor 100 being pixilated, the contact area may quickly saturate under a small amount of pressure. Accordingly, a further part of the percolation measurement is present. Specifically, as the resistance of the TPCC 115 is highly sensitive to pressure near the composition of the percolation threshold, applied pressure leads to small deformations of the material in the TPCC 115, thereby resulting in a resistivity decrease. This mode of operation is more sensitive in the higher force range when the contact area is saturated. However, the polymer matrix deformation has only started. Thus, depending on, for example, a Young's modulus of the polymer matrix, the polymer of the TPCC 115 may be adjusted so that the contact mode (i.e., for light touch) and the percolation mode (i.e., for hard press) make a smooth transition.

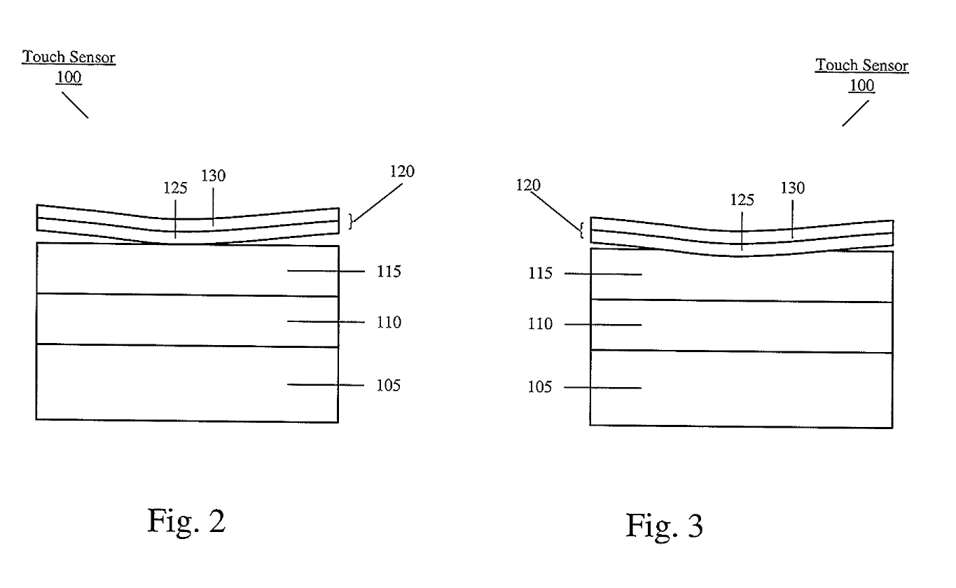

FIG. 2 is the touch sensor 100 of FIG. 1 upon applying a light touch input in accordance with some embodiments. Specifically, FIG. 2 relates to the contact mode in the hybrid operating mode of the touch screen 100. As illustrated in FIG. 2, when a pressure is applied from a light touch, the top layer 120 may deform. As discussed above, the top ITO 125 and the PET 130 of the top layer 120 may be sufficiently flexible to allow this deformation. The contact between the top layer 120 and the TPCC 115 may therefore increase a surface area of contact. However, as discussed above, the light touch may be insufficient to go beyond the percolation threshold. That is, deformations in the material of the TPCC 115 are not experienced.

FIG. 3 is the touch sensor 100 of FIG. 1 upon applying a hard press input in accordance with some embodiments. Specifically, FIG. 3 relates to the percolation mode in the hybrid operating mode of the touch screen 100. As illustrated in FIG. 3, when a pressure is applied from a hard press, the top layer 120 may also deform. Again, because the ITO 125 and the PET 130 of the top layer 120 are sufficiently flexible, this deformation is permitted. The contact between the top layer 120 and the TPCC 115 may therefore increase the surface area of contact in an amount that small deformations in the material of the TPCC 115 results in a resistivity decrease.

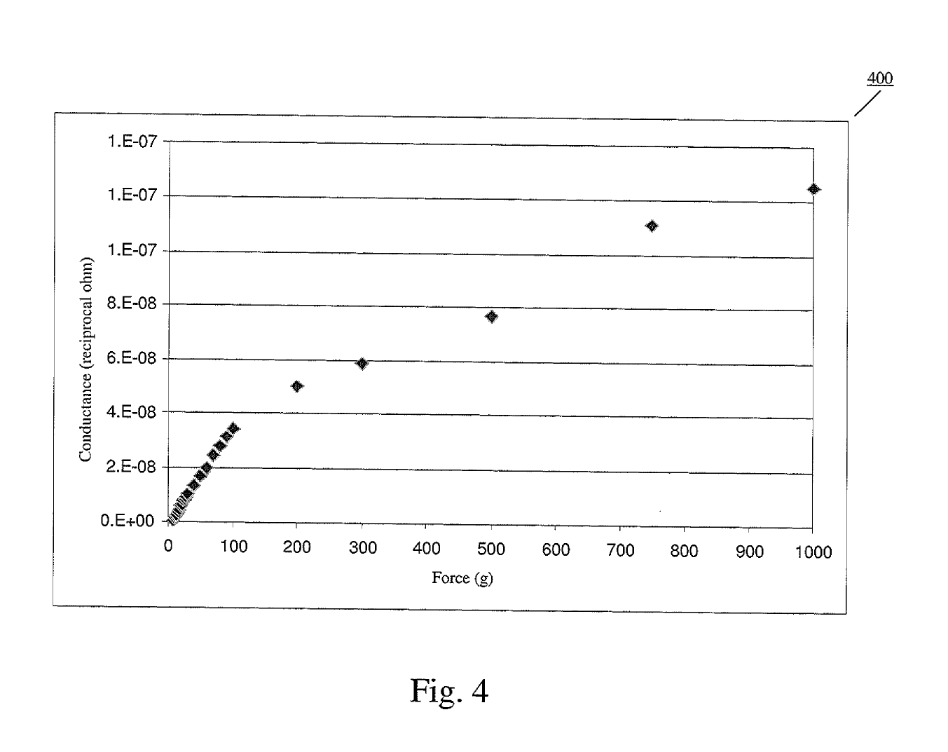

FIG. 4 is a graphical representation 400 of a conductance-force curve for the touch sensor 100 of FIG. 1 in accordance with some embodiments. As discussed above, the touch screen 100 is configured with the hybrid operating mode that is capable of determining between a light touch and a hard press. The TPCC 115 is configured in such a way as to easily distinguish between the light touch and the hard press. Specifically, when the percolation threshold is reached, the TPCC 115 generates data that may be interpreted to determine whether deformations in the material of the TPCC 115 results in the resistivity decrease. Thus, the graphical representation 400 shows that when a force is applied for a light touch (e.g., between 0 and 100 g), the conductance measured on the TPCC 115 corresponds to the light touch (e.g., between 0 and 4×10⁻⁸ reciprocal ohm [mho, siemens]). Those skilled in the art will understand that the conductance measured for the light touch follows a generally linear curve with a steep slope, given the dimensions of the axes of the graphical representation 400. That is, the resistivity does not decrease in a manner expected for a hard press. Accordingly, when a force is applied for a hard press (e.g., between 100 and 1000 g), the conductance measured on the TPCC 115 corresponds to the hard press (e.g., between 4×10⁻⁸ and 1×10⁻⁷). Those skilled in the art will understand that the conductance measured for the hard press also follows a generally linear curve with a low slope, given the dimensions of the axes of the graphical representation 400. That is, the resistivity decreases due to the deformations in the TPCC 115.

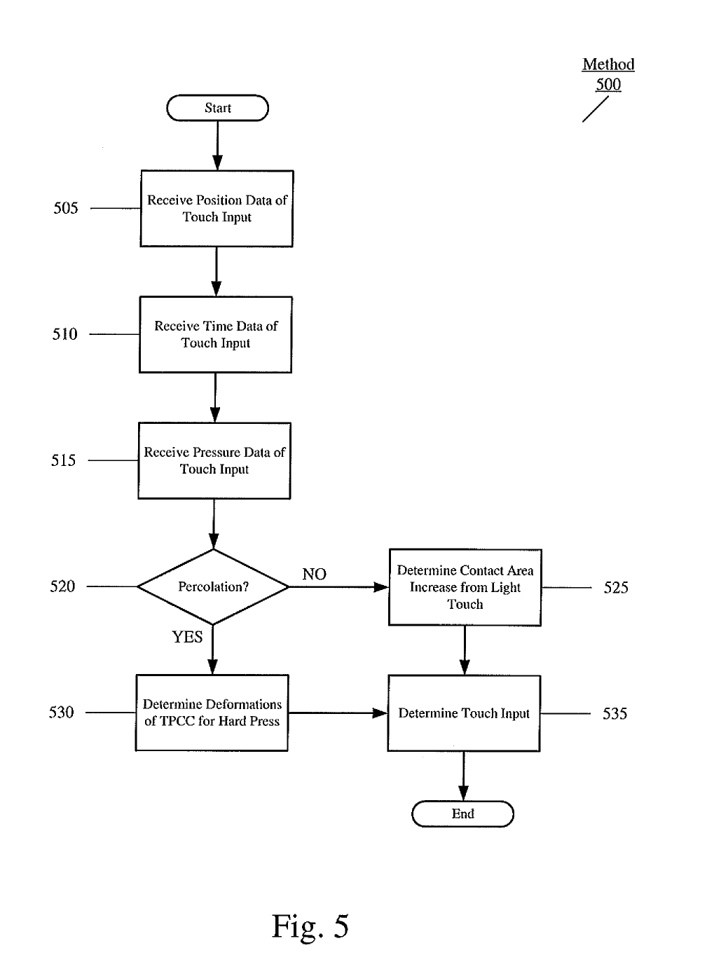

FIG. 5 is a flowchart of a method 500 for determining a touch input for the touch sensor 100 of FIG. 1 in accordance with some embodiments. The method 500 relates to receiving data regarding the three degrees of freedom of the touch input. The method 500 will be described with reference to the touch screen 100 of FIG. 1 and its components as well as the touch screens as illustrated in FIGS. 2 and 3.

In step 505, position data of the touch input is received on the touch screen 100. As discussed above, the touch screen 100 may be configured to determine the three degrees of freedom of the touch input: position, time, and pressure. Thus, in step 505, an initial measurement of the position data with respect to a surface area of contact on a top side of the top layer 120 in which the user is capable of touching is determined Those skilled in the art will understand that any conventional means of receiving the position data may be used. In step 510, time data of the touch input is received on the touch screen 100. A subsequent measurement of the time data with respect to an initial contact and a final contact of the touch input may be measured. Those skilled in the art will understand that any conventional means of receiving the time data may also be used.

In step 515, pressure data of the touch input is received. It should be noted that the touch screen 100 may receive the position data in step 505, the time data 510, and the pressure data in step 515 concurrently and process all the above data to determine the touch input. With regard to the exemplary embodiments of the present invention, the pressure data may further be analyzed in order to determine the type of pressure being applied by the touch input.

In step 520, a determination is made whether a percolation threshold is reached by the touch input. As discussed above, the touch screen 100 may be configured with a hybrid operating mode to incorporate both a light touch input and a hard press input. The percolation threshold may indicate when the touch input goes from a light touch to a hard press.

If the percolation threshold is not reached, then the method 500 continues to step 525. In step 525, a contact area increase from the light touch is determined As discussed above, particularly with reference to FIG. 2, the top layer 120 may contact the TPCC 115. Specifically, a contact area between the top layer 120 and the TPCC 115 may be determined. Accordingly, the light touch may be interpreted.

Returning to step 520, if the percolation threshold is reached, then the method 500 continues to step 530. In step 530, deformations of the TPCC 115 from the hard press is determined. As discussed above, particularly with reference to FIG. 3, the top layer 120 may contact the TPCC 115 in such a way as to generate deformations of the material contained in the TPCC 115. As such, the resistivity decreases as illustrated in the graphical representation 400 of FIG. 4. Accordingly, the hard press may be interpreted.

Upon receiving the position data of the touch input in step 505, the time data of the touch input 510, and the pressure data 515 with the interpretations provided in steps 525 and 530, in step 535, the touch input may be determined for all three degrees of freedom available for the touch input.

The exemplary embodiments of the present invention provide a touch screen that is configured for determining all three degrees of freedom of a touch input. In particular, the touch screen is capable of determining a pressure of the touch input between a light touch and a hard press. A TPCC may be disposed between a bottom ITO and a top layer including a PET and a ITO. When only a contact area is measured between the top layer and the TPCC, the touch screen may interpret the pressure data of the touch input as a light touch. When a contact area is measured between the top layer and the TPCC in which deformations are measured, the touch screen may interpret the pressure data of the touch input as a hard press.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
receiving a touch input on a top side of a top layer of a touch input receiving device;
measuring pressure data of the touch input, by an intermediate layer disposed beneath the top layer, the pressure data being indicative of distinguishing the touch input between a first touch and a second touch, the first touch having first a pressure less than a second pressure of the second touch; and
receiving at least one of position data, time data, and the pressure data of the touch input from a bottom layer of the touch input receiving device, the bottom layer disposed beneath the intermediate layer.

2. The method of claim 1, wherein the top layer includes a transparent conducting layer and a flexible transparent material.

3. The method of claim 2, wherein the transparent conducting layer is comprised of an indium tin oxide (ITO) layer and the flexible transparent material is polyethylene terephthalate (PET).

4. The method of claim 3, wherein the bottom layer is a further one of the transparent conducting layer.

5. The method of claim 4, wherein the transparent conducting layer is a further one of the ITO layer.

6. The method of claim 2, wherein the intermediate layer is comprised of a transparent polymer-conductor composite (TPCC) layer.

7. The method of claim 6, wherein the TPCC layer includes a transparent conducting oxide (TCO) nano particles dispersed in a transparent polymer matrix.

8. The method of claim 6, further comprising:
receiving an increase in a contact area between the TPCC layer and the top layer.

9. The method of claim 6, wherein the contact area corresponding to a lesser amount than a percolation threshold is indicative of the first touch, and wherein the contact area corresponding to a greater amount than the percolation threshold is indicative of the second touch.

10. The method of claim 9, wherein the percolation threshold is a function of a Young's modulus of the polymer matrix of the TPCC layer.

11. A touch input receiving device, comprising:
a top layer having a top side which is configured to receive a touch input;
an intermediate layer disposed beneath the top layer, the intermediate layer configured to measure pressure data, the pressure data being indicative of distinguishing the touch input between a first touch and a second touch, the first touch having a first pressure less than a second pressure of the second touch; and
a bottom layer disposed beneath the intermediate layer, the bottom layer configured to receive at least one of position data, time data, and the pressure data of the touch input,
wherein the touch input receiving device is transparent.

12. The device of claim 11, wherein the top layer includes a transparent conducting layer and a flexible transparent material.

13. The device of claim 12, wherein the transparent conducting layer is comprised of an indium tin oxide (ITO) layer and the flexible transparent material is polyethylene terephthalate (PET).

14. The device of claim 13, wherein the bottom layer is a further one of the transparent conducting layer.

15. The device of claim 14, wherein the transparent conducting layer is a further one of the ITO layer.

16. The device of claim 12, wherein the intermediate layer is comprised of a transparent polymer-conductor composite (TPCC) layer.

17. The device of claim 16, wherein the TPCC layer receives an increase in a contact area with the top layer.

18. The device of claim 17, wherein the contact area corresponding to a lesser amount than a percolation threshold is indicative of the first touch, and wherein the contact area corresponding to a greater amount than the percolation threshold is indicative of the second touch.

19. The device of claim 18, wherein the percolation threshold is a function of a Young's modulus of the polymer matrix of the TPCC layer.

20. A device, comprising:
a receiving means for receiving a touch input;
a measuring means for measuring pressure data, the pressure data being indicative of distinguishing the touch input between a first touch and a second touch, the first touch having a first pressure less than a second pressure of the second touch, the measuring means disposed beneath the receiving means; and
a further receiving means for receiving at least one of position data, time data, and the pressure data of the touch input, the further receiving means disposed beneath the measuring means.
